(19) United States
(12) Patent Application Publication
(10) Pub. No.: US 2018/0112432 A1
(43) Pub. Date: Apr. 26, 2018

(54) FOLDING VEHICLE ROOF TOP TENT UNDER MANUAL AND ELECTRIC CONTROL

(71) Applicant: YUAN CHENG AUTO ACCESSORIES MANUFACTURER CO., LTD., Taizhou (CN)

(72) Inventor: MENGFEI XU, TAIZHOU (CN)

(73) Assignee: YUAN CHENG AUTO ACCESSORIES MANUFACTURER CO., LTD., Taizhou (CN)

(21) Appl. No.: 15/396,618

(22) Filed: Dec. 31, 2016

(30) Foreign Application Priority Data
Oct. 21, 2016 (CN) 2016109193672

(51) Int. Cl. E04H 15/06; B60P 3/36; E04H 15/36; E04H 15/48

(52) U.S. Cl. CPC E04H 15/06; E04H 15/48; E04H 15/36; B60P 3/36

(57) ABSTRACT

A folding vehicle roof top tent under manual control and electric control, which comprises ejector rods consisting of a front ejector rod, a middle ejector rod and a rear ejector rod, a bed frame and tent cloth, the one ends of two electric ejectors are respectively hinged to a middle-lower part of two side walls of the middle ejector rod, the other ends of the two electric ejector rods are respectively hinged to two sides of the other end of the bed frame, a press button control panel provided on a side of the bed frame, the electric ejector rods drive the middle ejector rod to rotate, an adapter is fixed in the middle-lower part of the middle ejector rod, and the electric ejector rods realize the hinge/unhinge between the electric ejector rods and the middle ejector rod.

### CROSS REFERENCE TO RELATED PATENT APPLICATION

The present application claims the priority of CN 2016109193672 filed Oct. 21, 2016, which application is incorporated herein by reference.

### TECHNICAL FIELD

The invention falls within the technical field of vehicle roof top tents, and in particular relates to a vehicle roof top tent, of which the ascending and descending can be controlled both electrically and manually, and the automatic control can control the ascending and descending of the vehicle roof top tent both by a remote controller and a push button switch.

### BACKGROUND

As the owning amount of a private car has grown increasingly, self-driving trip has become an emerging way of tourism. In order to satisfy the requirement of convenience in the self-driving trips, the development of products which is attached to a vehicle and used for the self-driving trips has been progressing, and a vehicle tent is developed in this environment.

Vehicle tent refers to a tent which can be built on a roof top of the vehicle, and since the tent does not adjoin the ground like the other tents when in use, the tent is not susceptible to the intrusion by ground air and moisture, thereby being more comfortable in use.

However, the methods for ascending and descending current roof top tents are either fully automatic or manually; there is no roof top tent which can use both methods; in addition, the fully automatic ascending and descending methods are all controlled by a remote controller, and there is no roof top tent which can be controlled both by a remote controller and a press button switch.

### CONTENTS OF THE INVENTION

The purpose of the present invention is to provide a folding roof top tent under manual and electric control.

The object of the present invention is realized as follows:

A folding roof top tent under manual and electric control, which comprises a door-shaped ejector rod, wherein lower ends of two side rods of the ejector rods are hinged to two sides of one end of a bed frame, tent cloth is connected to the ejector rods, said ejector rods comprise a front ejector rod, a middle ejector rod and a rear ejector rod, the one ends of two electric ejectors are respectively hinged to a middle-lower part of two side walls of the middle ejector rod, the other ends of the two electric ejector rods are respectively hinged to two sides of the other end of the bed frame, the actions of the electric ejector rods is controlled by a remote controller and a press button control panel provided on a side of the bed frame, the remote controller and the press button control panel are both provided with press buttons controlling the ejector rods to ascend, descend and pause, the electric ejector rods drive the middle ejector rod to rotate so as to drive the tent cloth to stretch and retract, an adapter is fixed in the middle-lower part of the middle ejector rod, an end of the adaptor and an end of the electric ejector rods are both provided with a pin hole, and the mounting/detaching of a bolt or a screw in/from the pin hole of the adaptor and the electric ejector rods realize the hinge/unhinge between the electric ejector rods and the middle ejector rod.

The specific structure for the lower ends of two side rods of said ejector rods to be hinged to the two sides of the end of the bed frame is as follows: two U-shaped supports are correspondingly provided on both sides of the end of the bed frame, four pairs of articulation holes are provided spaced apart in an inclined manner from top to bottom on two opposite side walls of each U-shaped frame, the lower ends of the front ejector rod, the middle ejector rod and the rear ejector rod are correspondingly hinged in upper, middle, lower pairs of the articulation holes via an articulation shaft, a fourth pair of articulation holes is located in a rear part of the middle ejector rod when the middle ejector rod is upright, and the middle ejector rod can be positioned in the upright position by inserting a bolt in the fourth pair of articulation holes when the middle ejector rod is in the upright position.

Two sides of a lower bottom of the above-mentioned bed frame are provided with crossbeams parallel to each other, a bottom of each crossbeam is provided with a T-shaped groove penetrating in the axial direction, two or more anti-friction pads with an I-shaped cross section are fitted in the T-shaped groove, and a lateral width of the lower bottom of the anti-friction pads is greater than or equal to the width of the crossbeam.

A trapezoidal fixing sheet is provided on a lower side of the above-mentioned I-shaped anti-friction pads, the trapezoidal fixing sheet is fixed on the bottom of the crossbeam via a bolt, and an inverted trapezoidal hole is formed between the trapezoidal fixing sheet and the crossbeam for a lateral roof rod or a longitudinal roof rod on the roof to penetrate through.

A tie rope is tied to two sides of the above-mentioned front ejector rod, and an outer end part of the tie rope is connected to a hanger which can be hung on a wheel hub.

An independent telescopic ladder used for climbing from the ground to the tent in the roof is detachably provided at the above-mentioned bed frame.

The specific structure of the above-mentioned electric ejector rod is as follows: an electric motor is provided at a rear part of a cylinder, an outer thread is provided on a part of an electric motor rotating shaft extending out of the electric motor to forma screw shaft, an inner threaded sleeve with an inner thread is fitted on an inner wall of a front part of the cylinder, the screw shaft is screwed with the threaded sleeve, a tail end of the cylinder is hinged to the other end of the bed frame, and a front end of the threaded sleeve is hinged to the middle-lower part of the middle ejector rod.

The specific structure of the above-mentioned electric ejector rod is as follows: a gear is fixed on a rotation shaft of an electric motor provided in a middle part of the cylinder, a rack in meshed transmission with the gear is provided in an axial slide way in a sliding manner in the cylinder, the tail end of the cylinder is hinged to the other end of the bed frame, and a front end of the rack is hinged to the middle-lower part of the middle ejector rod.

Compared with the prior art, the present invention has the prominent and beneficial technical effects as follows:

1. After the electrical motor is connected to a vehicle power supply, press buttons for ascending, descending and pausing on a remote controller or a press button control panel can be used to control the ejector rods to ascend, descend, or remain at an arbitrary position, particularly, after any one of the remote controller and the press button control panel is defect, the other one can be used to control the ascending and descending of the ejector rods (tent) or maintain the ejector rods at an arbitrary position.

2. The present invention can rapidly realize the switching between manual control and the electric control by using the bolt or the screw inserted in the adaptor and the electric ejector rods: when the bolt or the screw inserted in the adaptor and the electric ejector rods is detached, the electric ejectors are no longer connected to the ejector rods, and the ejector rods can be ascended and descended by manually pulling the tie rope or manually rotating the ejector rods; when the ascending and descending of the ejector rods is controlled manually, since the self-locking function of the screw shaft and the threaded sleeve in the electric ejector rods is inactive, the bolt is needed to be inserted into the fourth pair of articulation holes so as to position the middle ejector rod after the ejector rod ascends to an upright position; when the bolt or the screw is inserted in the adaptor and the pin hole of the electric ejector rods, the electric ejector rods are connected to the ejector rods, and the ascending and descending of the ejector rods can be electrically controlled; since the tent has the function of fixedly connecting the middle ejector rod and the rear ejector rod, when the electric ejector rods drives the middle ejector rod to rotate forward while elevating and the tent drives the rear ejector rod to rotate forward; when the middle ejector rod rotates to the upright position, the front ejector rod is pushed to rotate forward and the front ejector rod is automatically rotated forward to a limit position of the tent by means of the gravity.

3. When the present invention is mounted on the vehicle roof top, due to the buffering function of the I-shaped anti-friction pads made of rubber or silica gel, mutual friction and scratch damage between a crossbeam and a lateral roof rod are reduced, thereby effectively protecting the crossbeam and the lateral roof rod.

4. After the present invention is mounted on the vehicle roof top, the hanger on the tie rope is used to hang on the wheel hub, and the front ejector rod can be pulled forward and fixed, thereby preventing the tent from being damaged by weather.

5. The present invention is suitable for the vehicle which has a lateral roof rod or a longitudinal roof rod mounted on the roof top.

### BRIEF DESCRIPTION OF THE DRAWINGS

FIG. 1 is a perspective schematic view of the present invention in an unfolded state without mounting a tent.

FIG. 2 is a front enlarged schematic diagram of a control panel of portion A in FIG. 1.

FIG. 3 is a perspective schematic view of the present invention in an unfolded state.

FIG. 4 is a perspective schematic view of the present invention in a partially unfolded state without mounting a tent.

FIG. 5 is a perspective schematic view of the present invention in a folded state without mounting a tent.

FIG. 6 is a perspective schematic view of the present invention in an automatic control state after being mounted on a vehicle roof.

FIG. 7 is a schematic view of a mounting process of the anti-friction pads of the present invention.

FIG. 8 is a partial structural cross-section view of the present invention in the B-B direction of FIG. 7.

FIG. 9 is a perspective schematic view of the present invention in a manual control state after being mounted on a vehicle roof.

FIG. 10 is an enlarged schematic view of portion C in FIG. 9.

FIG. 11 is a side view of the present invention without mounting a tent.

FIG. 12 is an enlarged schematic view of portion D in FIG. 11.

### SPECIFIC EMBODIMENTS

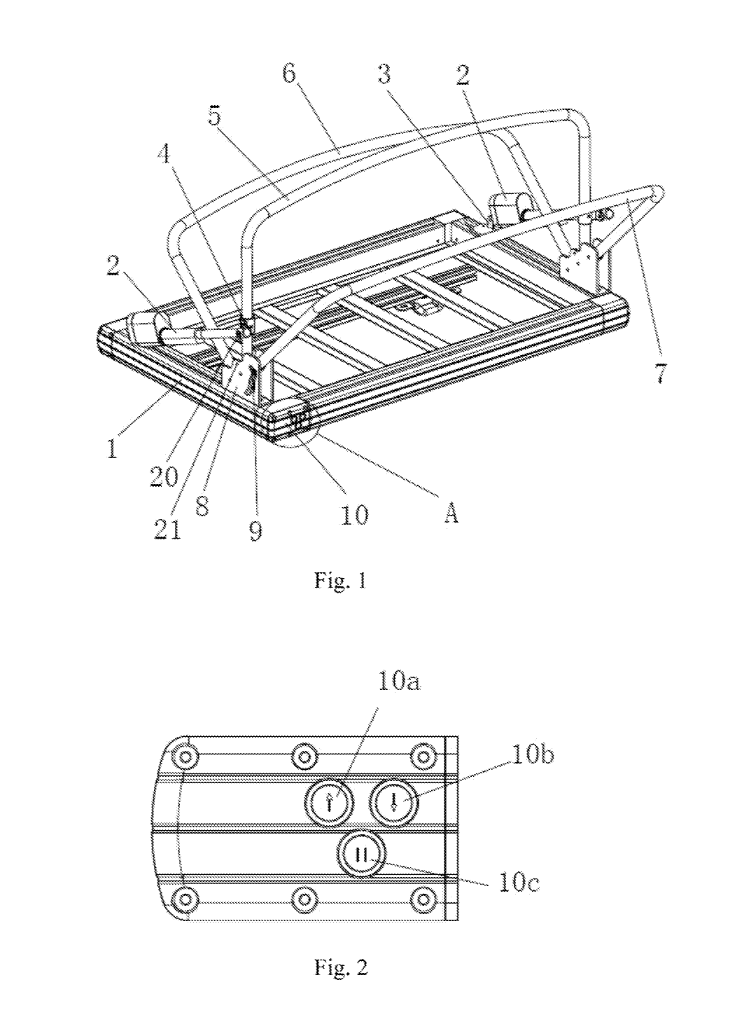

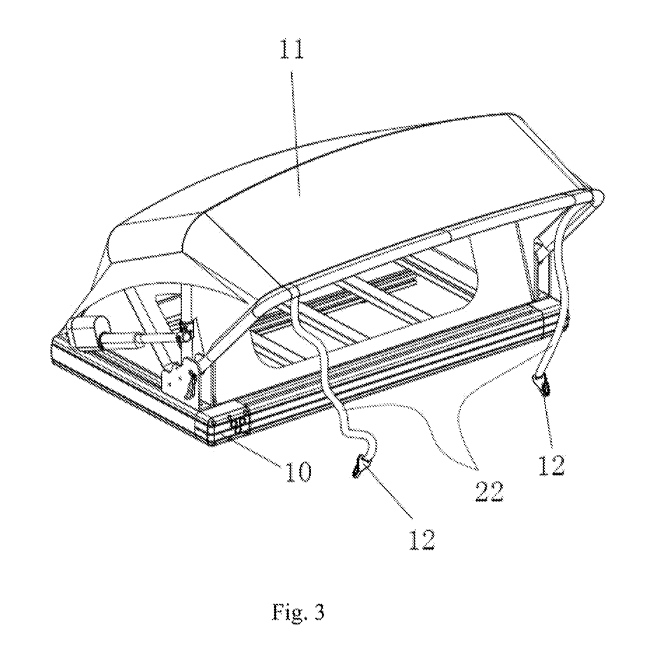

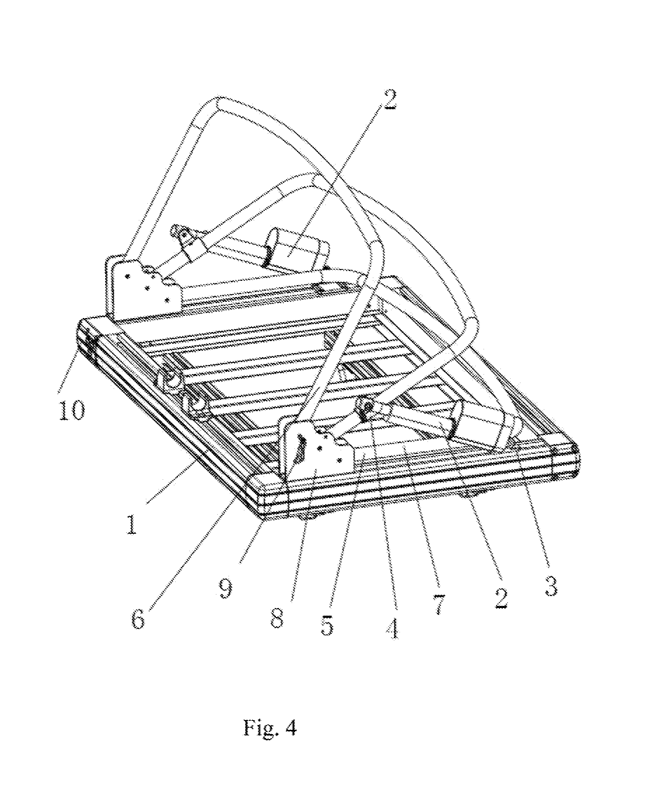

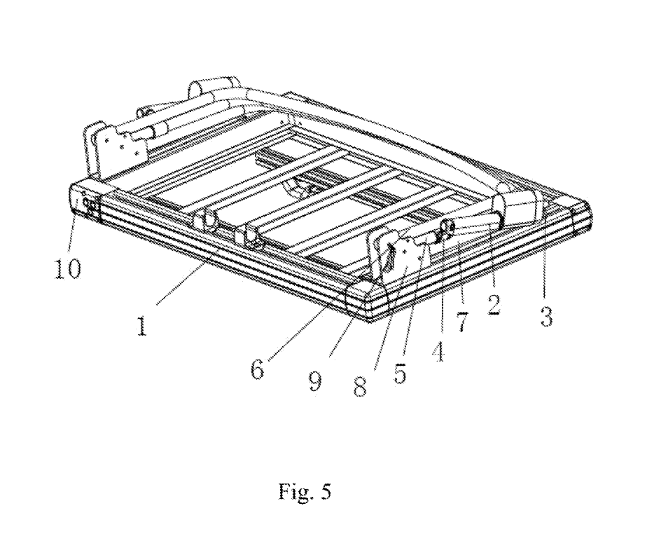

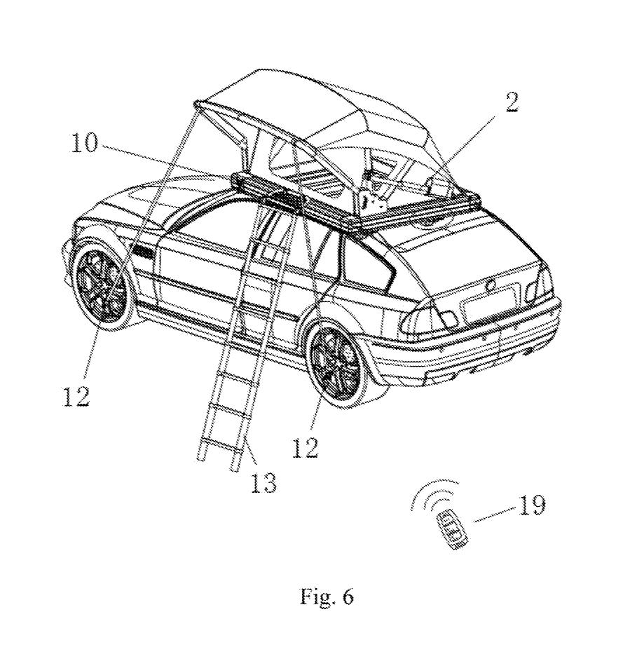

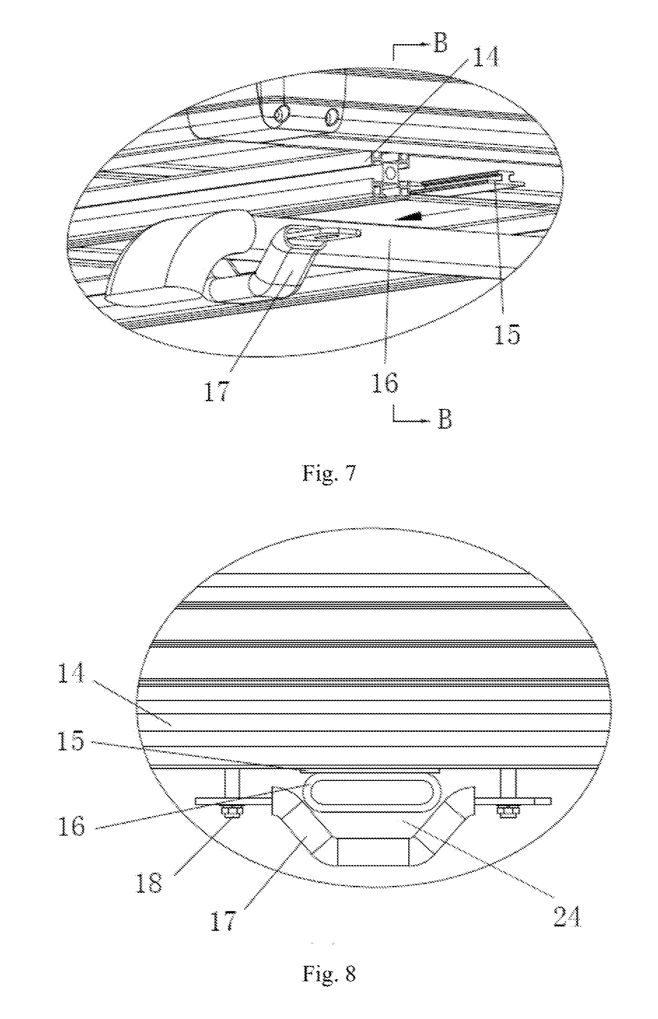

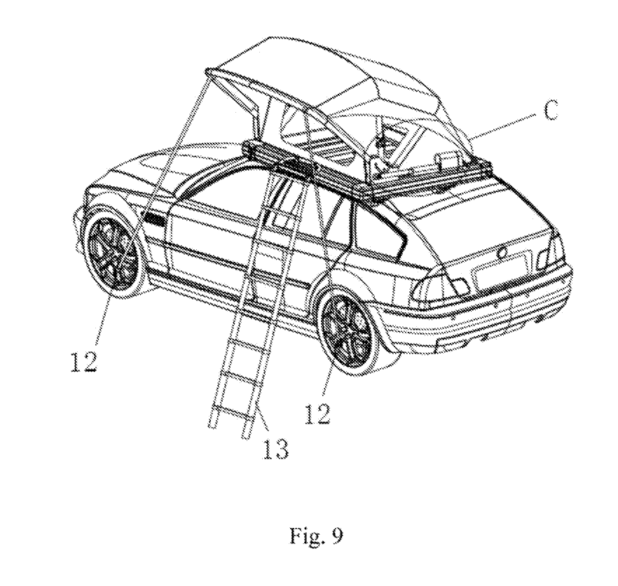

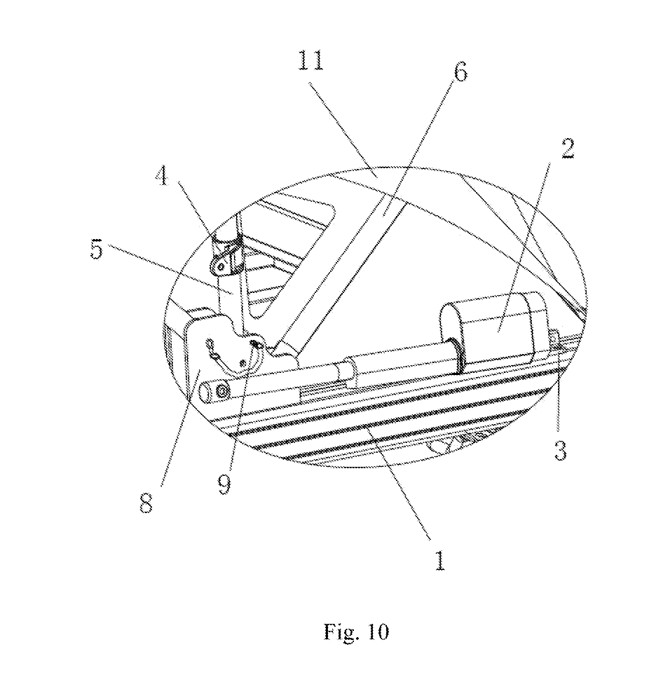

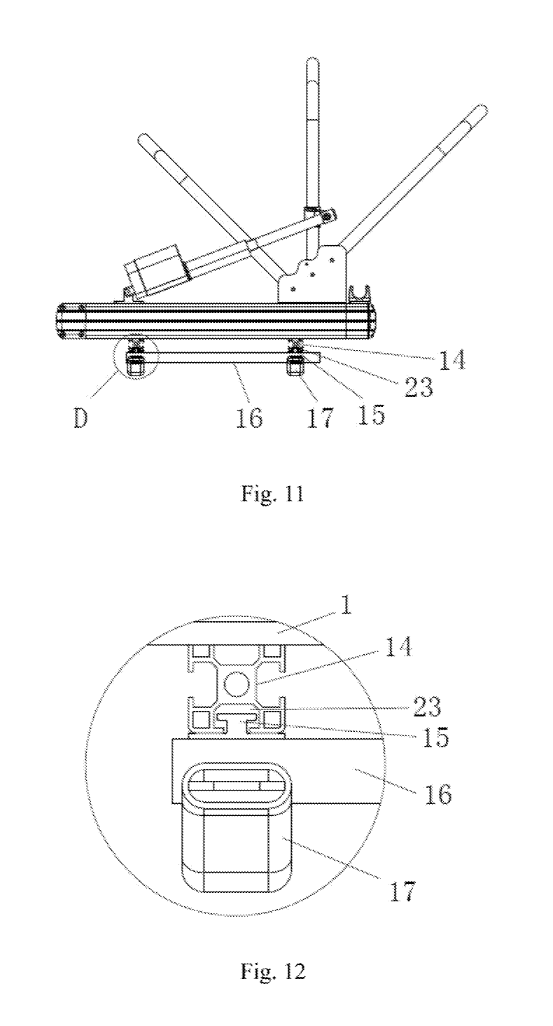

The present invention is further described in conjunction with the drawings and particular embodiments as below, see FIGS. 1-12:

A folding roof top tent under manual and electric control, which comprises a door-shaped ejector rod, wherein lower ends of two side rods of the ejector rods are hinged to two sides of one end of a bed frame 1, tent cloth 11 is connected to the ejector rods, said ejector rods comprise a front ejector rod 7, a middle ejector rod 5 and a rear ejector rod 6, the one ends of two electric ejectors 2 are respectively hinged to a middle-lower part of two side walls of the middle ejector rod 5, the other ends of the two electric ejector rods 2 are respectively hinged to two sides of the other end of the bed frame 1, the actions of the electric ejector rods 2 is controlled by a remote controller 19 and a press button control panel 10 provided on a side of the bed frame 1, the remote controller 19 and the press button control panel 10 are both provided with press buttons 10a, 10b, 10c controlling the ejector rods to ascend, descend and pause, the electric ejector rods 2 drive the middle ejector rod 5 to rotate so as to drive the tent cloth 11 to stretch and retract, an adapter 4 is fixed in the middle-lower part of the middle ejector rod 5, an end of the adaptor 4 and an end of the electric ejector rods 2 are both provided with a pin hole, and the mounting/detaching of a bolt or a screw 20 in the pin hole of the adaptor 4 and the electric ejector rods 2 realize the hinge/unhinge between the electric ejector rods 2 and the middle ejector rod 5.

The specific structure for the lower ends of two side rods of the above-mentioned ejector rod to be hinged to the two sides of the end of a bed frame 1 is as follows: two U-shaped supports 8 are correspondingly provided on two sides of the end of the bed frame 1, four pairs of articulation holes are provided spaced apart in an inclined manner from top to bottom on two opposite side walls of each U-shaped frame 8, the lowers ends of the front ejector rod, the middle ejector rod and the rear ejector rod are correspondingly hinged in upper, middle, lower pairs of articulation holes via an articulation shaft, a fourth pair of articulation holes is located in a rear part of the middle ejector rod 5 when the middle ejector rod is upright, and when the middle ejector rod 5 can be positioned in the upright position by inserting a bolt 9 in the fourth pair of articulation holes 21 when the middle ejector rod 5 is in the upright position; said bed frame 1 is formed by providing a plurality of lateral plates at intervals on a quadrilateral frame, and upper surfaces of the lateral plates are provided with a mattress or a lower side of the mattress is provided with a knitted palm fibrous mesh or is provided with a summer sleeping mat material so as to facilitate people relaxing or working on the mattress.

Two sides of a lower bottom of the above-mentioned bed frame 1 are provided with two crossbeams 14 parallel to each other, a bottom of each crossbeam 14 is provided with a T-shaped groove 23 penetrating in the axial direction, two or more anti-friction pads 15 with an I-shaped cross section are fitted in the T-shaped groove 23, a lateral width of the lower bottom of the anti-friction pads 15 is greater than or equal to the width of the crossbeam 14, and the widths and the lengths of the two crossbeams 14 are such that mounting of the bed frame 1 on the vehicle roof is facilitated.

A trapezoidal fixing sheet 17 is provided on a lower side of the above-mentioned anti-friction pads 15, the trapezoidal fixing sheet 17 is fixed on the bottom of the crossbeam 14 via a bolt 18, and an inverted trapezoidal hole 24 is formed between the trapezoidal fixing sheet 17 and the crossbeam 14 for a lateral roof rod 16 or a longitudinal roof rod on the roof to penetrate through, which facilitates clamping the lateral roof rod 16 or the longitudinal roof rod when the bed frame 1 is mounted on the roof.

A tie rope 22 is tied to two sides of the above-mentioned front ejector rod 7, an outer end part of the tie rope 22 is connected to a hanger 12 which can be hung on a wheel hub, and the tie rope 22 can be a steel wire rope or a rope such as a cotton rope or a nylon rope with an increased tensile force.

An independent telescopic ladder 13 used for climbing from the ground to the tent in the roof is detachably provided at the above-mentioned bed frame 1.

The specific structure of the above-mentioned electric ejector rod 2 is as follows: an electric motor is provided at a rear part of a cylinder, an outer thread is provided on a part of an electric motor rotating shaft extending out of the electric motor to form a screw shaft, an inner threaded sleeve with an inner thread is fitted on an inner wall of a front part of the cylinder, the screw shaft is screwed with the threaded sleeve, a tail end of the cylinder is hinged to an L-shaped connecting sheet 3, the L-shaped connecting sheet 3 is fixed at the other end of the bed frame, and a front end of the threaded sleeve is hinged to the middle-lower part of the middle ejector rod 5.

The specific structure of the above-mentioned electric ejector rod 2 is as follows: a gear is fixed on a rotation shaft of an electric motor provided in a middle part of the cylinder, a rack in meshed transmission with the gear is provided in an axial slide way in a sliding manner in the cylinder, the tail end of the cylinder is hinged to the L-shaped connecting sheet 3, the L-shaped connecting sheet 3 is fixed at the other end of the bed frame, and a front end of the rack is hinged to the middle-lower part of the middle ejector rod 5.

The embodiments described above are merely the preferred embodiments of the present invention, and are not intended to limit the scope of protection of the present invention, and therefore, equivalent changes made according to the shape, structure and principle of the present invention shall be contained within the scope of protection of the present invention.

What is claimed is:

1. A folding vehicle roof top tent under manual and electric control, which comprises a door-shaped ejector rod, lower ends of two side rods of the ejector rods being hinged to two sides of one end of a bed frame, tent cloth being connected to the ejector rods, characterized in that said ejector rods comprise a front ejector rod, a middle ejector rod and a rear ejector rod, the one ends of two electric ejectors are respectively hinged to a middle-lower part of two side walls of the middle ejector rod, the other ends of the two electric ejector rods are respectively hinged to two sides of the other end of the bed frame, the actions of the electric ejector rods is controlled by a remote controller and a press button control panel provided on a side of the bed frame, the remote controller and the press button control panel are both provided with press buttons controlling the ejector rods to ascend, descend and pause, the electric ejector rods drive the middle ejector rod to rotate to drive the tent cloth to stretch and retract, an adapter is fixed in the middle-lower part of the middle ejector rod, an end of the adaptor and an end of the electric ejector rods are both provided with a pin hole, and the mounting/detaching of a bolt or a screw in/from the pin hole of the adaptor and the electric ejector rods realize the hinge/unhinge between the electric ejector rods and the middle ejector rod.

2. The folding vehicle roof top tent under manual and electric control according to claim 1, characterized in that the specific structure for the lower ends of two side rods of said ejector rods to be hinged to the two sides of the end of the bed frame is as follows: two U-shaped supports are correspondingly provided on both sides of the end of the bed frame, four pairs of articulation holes are provided spaced apart in an inclined manner from top to bottom on two opposite side walls of each U-shaped frame, the lower ends of the front ejector rod, the middle ejector rod and the rear ejector rod are correspondingly hinged in upper, middle, lower pairs of the articulation holes via an articulation shaft, a fourth pair of articulation holes is located in a rear part of the middle ejector rod when the middle ejector rod is upright, and the middle ejector rod can be positioned in the upright position by inserting a bolt in the fourth pair of articulation holes when the middle ejector rod is in the upright position.

3. The folding vehicle roof top tent under manual and electric control according to claim 1, characterized in that two sides of a lower bottom of said bed frame are provided with crossbeams parallel to each other, a bottom of each crossbeam is provided with a T-shaped groove penetrating in the axial direction, two or more anti-friction pads with an I-shaped cross section are fitted in the T-shaped groove, and a lateral width of the lower bottom of the anti-friction pads is greater than or equal to the width of the crossbeam.

4. The folding vehicle roof top tent under manual and electric control according to claim 3, characterized in that a trapezoidal fixing sheet is provided on a lower side of said anti-friction pads, the trapezoidal fixing sheet is fixed on the bottom of the crossbeam via a bolt, and an inverted trapezoidal hole is formed between the trapezoidal fixing sheet and the crossbeam for a lateral roof rod or a longitudinal roof rod on the vehicle roof to penetrate through.

5. The folding vehicle roof top tent under manual and electric control according to claim 1, characterized in that a tie rope is tied to two sides of said front ejector rod, and an outer end part of the tie rope is connected to a hanger which can be hung on a wheel hub.

6. The folding vehicle roof top tent under manual and electric control according to claim 1, characterized in that an independent telescopic ladder used for climbing from the ground to the tent on the roof is detachably provided at said bed frame.

7. The folding vehicle roof top tent under manual and electric control according to any of claim 1, characterized in that the specific structure of said electric ejector rod is as follows: an electric motor is provided at a rear part of a cylinder, an outer thread is provided on a part of an electric motor rotating shaft extending out of the electric motor to form a screw shaft, an inner threaded sleeve with an inner thread is fitted on an inner wall of a front part of the cylinder, the screw shaft is screwed with the threaded sleeve, a tail end of the cylinder is hinged to the other end of the bed frame, and a front end of the threaded sleeve is hinged to the middle-lower part of the middle ejector rod.

8. The folding vehicle roof top tent under manual and electric control according to any of claim 1, characterized in that the specific structure of said electric ejector rod is as follows: a gear is fixed on a rotation shaft of an electric motor provided in a middle part of the cylinder, a rack in meshed transmission with the gear is provided in an axial slide way in a sliding manner in the cylinder, the tail end of the cylinder is hinged to the other end of the bed frame, and a front end of the rack is hinged to the middle-lower part of the middle ejector rod.
